(19) United States
(12) Patent Application Publication
(10) Pub. No.: US 2024/0401437 A1
(43) Pub. Date: Dec. 5, 2024

(54) EQUIPMENT, METHOD & COMPUTER PROGRAM PRODUCT

(71) Applicant: EPIROC ROCK DRILLS AKTIEBOLAG, Örebro (SE)

(72) Inventors: Anders PERSSON, Hammarö (SE); Patrik MALM, Vintrosa (SE)

(21) Appl. No.: 18/699,506

(22) PCT Filed: Sep. 23, 2022
(86) PCT No.: PCT/SE2022/050849

§ 371 Date: Apr. 8, 2024

(30) Foreign Application Priority Data
Oct. 8, 2021 (SE) 2151230-6

(51) Int. Cl. E21B 41/00; E21B 7/02; H01M 10/42; H01M 10/44; H01M 10/48; H01M 50/249

(52) U.S. Cl. CPC E21B 41/00; E21B 7/022; E21B 7/027; H01M 10/425; H01M 10/44; H01M 10/48; H01M 50/249; H01M 2220/20

(57) ABSTRACT

Mining or construction equipment including at least one work device and at least one external supply unit that includes at least one of: at least one electrical energy storage device that is configured to supply energy to the at least one work device and/or at least one converter that is configured to convert electrical energy from an external electricity supply to electrical energy for the at least one work device and to supply the electrical energy to the at least one work device. The mining or construction equipment also includes at least one branched or unbranched connection that is configured to connect at least one of the components arranged on the at least one external supply unit to the at least one work device.

### TECHNICAL FIELD

The present invention concerns mining or construction equipment comprising at least one work device. The present invention also concerns a method for supplying energy to at least one work device of such mining or construction equipment, and a computer program product for use in a such mining or construction equipment or such a method.

### BACKGROUND OF THE INVENTION

Mining and construction companies around the world are engaged in efforts to reduce greenhouse gas emissions from fossil fuels to lessen environmental impact and create a healthier and safer work environment. These efforts include replacing fossil fuels with renewable energy, electrifying the equipment used in the mining and construction industry, and increasing energy efficiency to eliminate or minimize carbon dioxide emissions.

For example, European patent no. EP 2,356,730 B1 relates to a method for using a mining vehicle equipped with an on-board energy storage device, such as a battery or capacitor. When the mining vehicle is at a work site, its work device, hydraulic system and any necessary auxiliary systems are driven by electrical energy obtained from an external electrical network. The on-board energy storage device of the mining vehicle is charged during the work cycle when the mining vehicle is at the work site. After the work cycle is completed, electricity obtained from the on-board energy storage device is used to supply electric current to the driving equipment of the mining vehicle so that the mining vehicle can be moved between work sites without a combustion engine. The mining vehicle may be equipped with converters which are used to convert the electricity supplied from the electrical network to suit the requirements of the mining vehicle.

### SUMMARY OF THE INVENTION

An object of the invention is to provide improved mining or construction equipment comprising at least one work device.

This object is achieved by mining or construction equipment that comprises at least one external supply unit that comprises at least one electrical energy storage device that is configured to supply energy to the at least work device. Alternatively, or additionally, the at least one external supply unit comprises at least one converter that is configured to convert electrical energy from an external electricity supply to electrical energy that is suitable for the at least one work device, and to supply the electrical energy to the at least one work device. The mining or construction equipment also comprises at least one branched or unbranched connection that is configured to connect at least one of the components of the at least one external supply unit to the at least one work device and to supply energy from the at least one external supply unit to the work device.

The at least one work device is thereby provided with an at least one external, or off-board, energy supply that is either arranged on at least one external supply unit, or provided via at least one external supply unit.

There are several advantages with such an arrangement. It increases a manufacturer's design options since one or more of the components that have conventionally been located inside or on the housing of a work device, are arranged remotely to the work device on a separate external supply unit that supplies energy to the work device by means of at least one connection.

By reducing the number of components that need to be included inside or on the body of a work device, the cost, size, weight, and complexity of the work device may be reduced. Since a component that is arranged on an external supply unit may be easier and quicker to access, repair or replace than an internal component of a work device, maintenance and repair work may be easier to carry out and downtime may consequently be decreased. Similarly, since such a work device contains fewer internal components, its internal components may also be easier and quicker to access, repair or replace.

Furthermore, since an external supply unit may be located in a more protected, less exposed and/or more stable environment than the location in which a work device is located when it is carrying out a work task, i.e. in a location where there is less dust and dirt, fewer vibrations and/or smaller temperature fluctuations, the risk of damage to the components on the external supply unit will be decreased and the useful lifetime of the components will consequently be increased. Dangerous, sensitive, and/or complex components arranged on an external supply unit may be moved to a safe, or safer location, for example at work sites where there is a high risk of a landslide.

Additionally, in embodiments in which at least one converter is arranged on the at least one external supply unit, a leaner, more flexible cable may be used to supply electrical energy to the at least one work device than in conventional solutions. Furthermore, the at least one converter makes it possible to supply the at least one work device with electric energy that suits its requirements irrespective of the properties and quality of the electrical energy available from an external electricity supply.

Even if a work device comprises its own internal power supply, the present invention allows for a longer operating time since an external supply unit may be used to provide the work device with an additional or back-up energy supply. There may namely not be enough space in a battery-powered work device to accommodate a battery that is as large as the battery or batteries that can be arranged on at least one external supply unit. Additionally, a single external supply unit may be arranged to supply energy to a plurality of work devices simultaneously.

A further advantage is that the transportation of mining and construction equipment the is simplified since, rather than moving one large, heavy work device, a smaller and lighter work device and one or more external supply units may be moved separately, which means that smaller and/or less powerful vehicles may be used to transport the mining and construction equipment.

According to an embodiment of the invention the at least one work device and the at least one external supply unit are arranged to be independently movable. The at least one work device and the at least one external supply unit may for example be arranged to be moved with respect to one another before and/or during and/or after the use of the external supply unit to supply energy to the at least one work device.

According to an embodiment of the invention the at least one work device and/or the at least one external supply unit is/are each arranged on at least one powered or unpowered carriage. A powered work device and/or a powered external supply unit may namely be arranged to move themselves, using locally or remotely controlled drive means, such as an electric motor. Alternatively, an unpowered work device and/or an unpowered external supply unit or be arranged to be moved by an operator or by a machine, such as by a vehicle.

According to an embodiment of the invention the at least one external supply unit is mechanically, magnetically, or electromagnetically connectable to the at least work device. Such a mechanical, magnetic, or electro-magnetic connection is arranged to at least temporarily join the at least one supply to the at least work device. The at least one connection for supply energy to the at least one work device may comprise a such a mechanical, magnetic, or electro-magnetic connection integrally formed therewith.

According to an embodiment of the invention the at least one electrical energy storage device comprises at least one of the following: a battery, a re-chargeable battery, a fuel cell, and/or a capacitor.

According to an embodiment of the invention the at least one external supply unit also comprises at least one electric and/or hydraulic and/or pneumatic and/or mechanical component.

The at least one electric and/or hydraulic and/or pneumatic and/or mechanical component may be configured to be directly or indirectly connected to the at least one work device and/or to the at least one electric energy storage device or converter arranged on the at least one external supply unit. The at least one electric and/or hydraulic and/or pneumatic and/or mechanical component may comprise at least one of the following components: an electric motor, an electric generator, a compressor, a pump, one or more valves, a cooling system, a transformer, an electronic filter, an electric or electronic circuit, a sensor, a global positioning system (GPS) monitor, a reel winder, and/or a junction box, mechanical connection means.

According to an embodiment of the invention the at least one work device comprises at least one re-chargeable on-board energy storage device, and the at least one component that is arranged on the at least one external supply unit is configured to supply energy to the at least one re-chargeable on-board energy storage device to recharge it. The at least one re-chargeable on-board energy storage device may be configured to drive the work device and/or to supply power for limited work tasks and/or to transport the work device between work sites. The at least one electrical energy storage device or the at least one converter arranged off-board on the at least one external supply unit may be used to re-charge the at least one work device's re-chargeable on-board energy storage device(s) before and/or during and/or after the use of the at least one work device, i.e. before and/or during and/or after a work task.

According to an embodiment of the invention the mining or construction equipment comprises at least one control unit that is configured to monitor and/or control at least one of the following: a relative movement between the at least work device and the at least one external supply unit, an extension or location of the at least one branched or unbranched connection, a supply of energy to the at least work device and/or the at least one external supply unit, an amount of electrical energy stored in the at least one electrical energy storage device arranged on the at least one external supply unit, an amount of energy stored in the at least one re-chargeable on-board energy storage device of the at least one work device, and/or at least one work task performed by the at least one work device.

According to an embodiment of the invention mining or construction equipment comprises a plurality of control units that are arranged to communicate with one another. One or more control units may be configured to place the at least one external supply unit and the at least one work device in a suitable or optimum location with respect to each other. The at least one external supply unit may for example comprise at least one sensor and/or a GPS monitor to allow a control unit to monitor its position and/or movement.

According to an embodiment of the invention the at least one control unit is arranged on the at least one external supply unit. Alternatively, or additionally, the at least one control unit may constitute part of the at least one connection and/or be arranged at a node of a branched connection. The at least one control unit may comprise a local or remote display means and/or be arranged to communicate with a local or remote operator.

The present invention also concerns a method for supplying energy to mining or construction equipment comprising at least one work device, which may be carried out using the mining or construction equipment according to any of the embodiments of the present invention. The method comprises the steps of: providing at least one external supply unit comprising at least one of the following components: at least one electrical energy storage device that is configured to supply energy to the at least work device, and/or at least one converter that is configured to convert electrical energy from an external electricity supply to electrical energy that is suitable for the at least one work device, and to supply the electrical energy to the at least one work device. According to an embodiment of the invention the method comprises the step of providing the at least one external supply unit with at least one electric and/or hydraulic and/or pneumatic and/or mechanical component.

According to an embodiment of the invention the method comprises the step of arranging the at least one work device and/or the at least one external supply unit on at least one powered or unpowered carriage.

According to an embodiment of the invention the method comprises the step of mechanically, magnetically, or electromagnetically connecting the at least one external supply unit to the at least one work device, for example to move the at least one work device and/or the at least one external supply unit.

According to an embodiment of the invention the method comprises the step of providing the at least one work device with at least one re-chargeable on-board energy storage device, and supplying energy from at least one component arranged on the at least one external supply unit to the at least one re-chargeable on-board energy storage device to recharge it.

According to an embodiment of the invention, the method comprises the step of recharging the at least one re-chargeable on-board energy storage device of the at least one work device before and/or during and/or after the use of the at least one work device.

According to an embodiment of the invention the method comprises the step of providing at least one control unit and monitoring and/or controlling at least one of the following: a relative movement between the at least work device and the at least one external supply unit, an extension or location of the at least one branched or unbranched connection, a supply of energy to the at least work device and/or the at least one external supply unit, an amount of energy stored in the at least one electrical energy storage device arranged on the at least one external supply unit, an amount of energy stored in the at least one re-chargeable on-board energy storage device of the at least one work device, and/or at least one work task performed by the at least one work device.

The present invention further concerns a computer program product for mining or construction equipment according to any of the embodiments of the mining or construction equipment or method described herein. The computer program product comprises a computer program containing computer program code means arranged to cause a computer or a processor to monitor and/or control at least one of the following: —a relative movement between the at least work device, and the at least one external supply unit, —an extension or location of the at least one branched or unbranched connection, a supply of energy to the at least work device and/or the at least one external supply unit, an amount of energy stored in the at least one electrical energy storage device arranged on the at least one external supply unit, an amount of energy stored in the at least one re-chargeable on-board energy storage device of the at least one work device, and/or at least one work task performed by the at least one work device, whereby the computer program is stored on a computer-readable medium or a carrier wave.

### Definitions

The term “mining or construction equipment” is intended to mean any automated or non-automated equipment that is used in applications such as exploration, surface mining or quarrying and/or underground mining in the mining, construction or infrastructure industries.

The term “work device” is intended to mean any automated or non-automated device that is configured to carry out a work task, such as drilling, cutting, loading, hauling, materials handling or ventilating. A work device may comprise at least one of the following: a rock drilling, cutting, loading or hauling device, a drill rig, such as a face, surface, or well drill rig, an oil and gas drill rig, a rotary blasthole drill rig, an underground ventilation system device, an excavator, and/or a materials handling device. The work device may be at least partially, or completely electrically driven. The work device may however be entirely without its own power unit, whereby its sole energy source is the energy supplied by the at least one external supply unit.

The term “external supply unit” is intended to mean a location at which at the at least one component is placed, or any suitable entity comprising the at least one component. The entity may be a container, such as a box attached to a wall of a mine, a building, such as a simple roofed structure used for storage and/or shelter, such as a shed, a housing, or a carriage for conveying the at least one component, such as a wheeled or tracked carriage, such as a trailer or vehicle. An external supply unit is not located at the same location as the work device and it does not form an integral part of the work device when the external supply unit is in use, i.e. it is not arranged to be located inside or on the housing of the work device when the external supply unit is in use, i.e. when it is supplying energy to the work device and an external supply unit does not necessarily have to move when the at least one work device is moved, i.e. an external supply unit can be configured to be moved independently of the at least one work device. A removable component of a work device, such as a removable battery, is not an external supply unit within the meaning of this document since a removable battery has to be put back into the work device when it is being used to supply electrical energy to the work device.

The term “housing” is intended to mean a casing that encloses and/or protects a piece of moving or non-moving equipment, such as at least one component of a work device, or at least one dust-, or temperature-, or humidity-, damage- or vibration-sensitive component.

The term “carriage” is intended to mean any transport means for conveying at least one component from a first location to a second location.

An external supply unit according to the present invention constitutes a relocated contact point for at least one component of the mining or construction equipment, whereby the at least one component of conventional mining or construction equipment is moved to a new place.

At least one external supply unit may comprise at least one, some, a majority, or all of the components of at least one work device that do not necessarily need to be located together with the at least one part of the at least one work device that makes physical contact with a material or surface on which a work task is to be carried out. This means one or more components of at least one work device that do not necessarily need to be in the same housing, or in the vicinity of such a part, but can be located at a separate location that is at least one metre, or at least two metres, or at least five metres, or at least 10 metres, or at least 20 metres, or at least 30 metres, or at least 50 metres, or at least 100 metres, or at least 200 metres away from a point at which a part of a work device makes physical contact with a material or surface on which a work task is to be carried out. The number of components that need to be included inside, or on, or around the body of the at least one work device can thereby be kept to a minimum, which may reduce the cost, size, weight, and complexity of the at least one work device.

The term “supply energy to the work device” is intended to mean the supply of either electrical energy, such as direct current or alternating current, or energy in the form of hydraulic or pneumatic fluid or mechanical force. Such energy may be supplied directly to a work device, such as to a component of the work device, such as to its drive means or transportation means. Alternatively, or additionally, such energy may be supplied to a work device indirectly. For example, an external supply unit may be configured to supply electrical energy to one or more electric or hydraulic or pneumatic or mechanical components arranged on the external supply unit, one or more of which are configured to then supply energy in the form of electrical energy or hydraulic or pneumatic fluid, or mechanical force to the at least one work device.

Energy may be supplied to the at least one work device before and/or during and/or after the use of the at least one work device, i.e. while a work device is carrying out a work task, before a work device has started a work task, and/or after a work device has completed a work task. Electrical energy supplied to drive the at least one work device may be used to drive the at least one work device, i.e. to supply at least part of the operating power required for at least part of a work task, and/or to re-charge an on-board rechargeable electrical energy storage device of the at least one work device and/or to move the at least one work device between work sites, and/or to power any auxiliary system of the at least one work device that requires electrical energy, i.e. electrical energy may be supplied to any part of the mining or construction equipment that requires electrical energy before and/or during and/or after the operation of the at least one work device. The transportation means used to support or transport a work device is also considered to be part of the work device.

The term “on-board” is intended to mean something situated in or on the at least one work device when the at least one work device is in use, or something controlled by control means incorporated in the at least one work device when the at least one work device is in use, or something connected to at least one component that is incorporated in, or located on the at least one work device when the at least one work device is in use.

The term “at least one connection” may be at least one electrical connection, such as a cable or any other means for conducting electrical energy. It may be at least one hydraulic connection, such as a pipe or tube, for conveying hydraulic fluid, such as mineral oil, water or any other hydraulic liquid. It may be at least one pneumatic connection, such as a pipe or tube, for conveying pneumatic fluid, such as compressed air or inert gas, or any other pneumatic gas. It may even be a hybrid connection suitable for conducting electrical energy and for conveying hydraulic and/or pneumatic fluid, whereby the number of connections required between an external supply unit and a work device may be reduced.

The term “branched” connection is intended to mean a connection having a main part and at least one extending part (branch) that extends from the main part, whereby the connection is configured to conduct/convey electricity or hydraulic fluid or pneumatic fluid or mechanical force along the main part of the connection and along the at least one branch to a plurality of destinations, i.e. to a plurality of components, a plurality of work devices, or a plurality of parts of a single component.

The term “unbranched” connection is intended to mean a connection that is not divided into branches but is configured to conduct/convey electricity or hydraulic fluid or pneumatic fluid or mechanical force to a single destination, such as a single component, a single work device or a single part of a component.

The term “converter” is intended to mean any electromagnetic device that is arranged to convert electrical energy from an external electricity supply, such as an electrical network or any electric energy storage device, to electrical energy that suits the requirements of the at least one work device or some other part of the mining or construction equipment, such as an on-board battery of the mining or construction equipment. The converter may comprise a frequency converter, a voltage converter, a transformer, an alternating current (AC) to direct current (DC) converter or an inverter (that converts DC to AC).

The term “independently movable” is intended to mean that an entire external supply unit may move, or be moved by an operator or a machine, from one location to another without having to simultaneously move an entire work device that it supplies with energy. Preferably, the at least one external supply unit and the at least one work device are independently movable when the at least one component arranged on the external supply unit has been connected to the at least one work device using the at least one connection for supplying energy to the work device. Likewise, an entire work device is arranged may be arranged to move, or be moved by an operator or a machine from one location to another without having to move the entire external supply unit that supplies it with energy, preferably even when the at least one component arranged on the at least one external supply unit has been connected to the at least one work device using the at least one connection for supplying energy to the work device.

### BRIEF DESCRIPTION OF THE DRAWINGS

The present invention will hereinafter be further explained by means of non-limiting examples with reference to the appended schematic figures where;

FIGS. 1-4 show mining or construction equipment according to embodiments of the invention, and

FIG. 5 shows the steps of a method according to an embodiment of the invention.

It should be noted that the drawings have not necessarily been drawn to scale and that the dimensions of certain features may have been exaggerated for the sake of clarity.

Any feature of any embodiment of the mining or construction equipment, method or computer program product depicted or described in any part of this document may be combined with any one or more features of any other embodiment, unless such a combination is explicitly excluded herein.

### DETAILED DESCRIPTION OF EMBODIMENTS

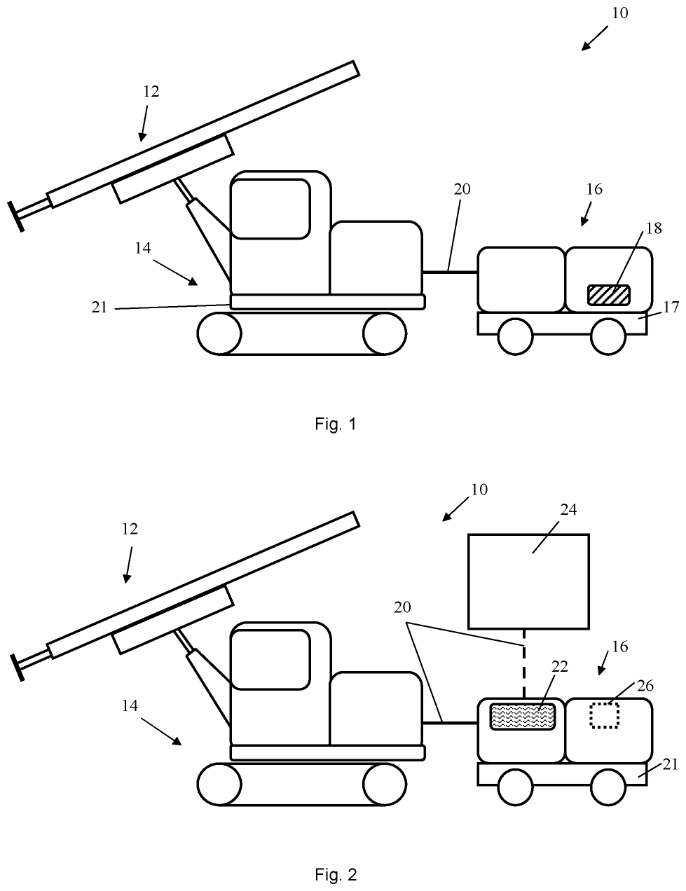

FIG. 1 shows mining or construction equipment 10 comprising a work device 12, namely a rock drill. The mining or construction equipment 10 comprises an external supply unit 16 on which an electrical energy storage device 18, such as a battery, is arranged. The electrical energy storage device 18 is configured to supply electrical energy to the work device 12 by means of an unbranched connection 20, such as a cable or any other means for conducting electrical energy.

According to an embodiment of the invention the mining or construction equipment 10 comprises at least one connection 20 arranged on at least one reel. The at least one reel may be arranged on at least one external supply unit 16 and/or on at least one work device 12 and/or at any suitable location at a work site. The at least one connection 20 may comprise a suitable connector that may be used to connect the connection to a work device 12 or to a component arranged on the at least one supply unit 16 or to an external electricity supply 24.

In the illustrated embodiment, the work device 12 is arranged on a powered carriage 21, such as an electrically driven vehicle having its own electric motor. The external supply unit 16 is arranged on an unpowered carriage 17, such as a trailer. The only connection between the external supply unit 16 and the work device 12 is the connection 20 that supplies energy from the electrical energy storage device 18 to the work device 12.

FIG. 2 shows an external supply unit 16 arranged on a powered carriage 21. A converter 22 is arranged on the external supply unit 16. The converter 22 is connected to an external electricity supply 24, such as an electrical network, by means of a connection 20. The external electricity supply 24 supplies the converter 22 with alternating current (AC) and the converter 22 is configured to convert the alternating current (AC) to direct current (DC) and supply the direct current (DC) to a work device 12 by means of a connection 20.

According to an embodiment of the invention, the at least one converter 22 may be configured to convert electrical energy from the at least one electric energy storage device 18 that is arranged on the at least one supply unit 16 to electrical energy that suits the requirements of the at least one work device 12.

The external supply unit 16 also comprises a control unit 26 configured to monitor and/or control the relative movement between the work device 12 and the external supply unit 16, the extension or location of the connection 20, the supply of electrical energy to the work device 12 and/or to the external supply unit 16 and/or the consumption of electrical energy by the work device 12. The external supply unit 16 may comprise at least one sensor or GPS monitor and display and/or communication means to present or communicate information to a local and/or remote operator.

According to an embodiment of the invention the least one control unit 26 may be used to position the at least one external supply unit 16 at an optimal position with respect to the at least one work device 12, and/or a work area, and/or according to a planned work schedule.

According to an embodiment of the invention at least one control unit 26 may be used to ensure that the at least one connection 20 does not get caught on a work device 12 or an external supply unit 16 or on the ground or surface over which it extends, and/or that it does get twisted, tangled, damaged, blocked, worn, run over and/or short-circuited. A control unit 26 may namely be configured to ensure that the at least one connection 20 extends in a safe and suitable way, over a suitable distance, in a suitable direction, and/or at a suitable angle for example.

According to an embodiment of the invention at least one external supply unit 16 may comprise a reel winder and the at least one control unit 26 may be used to control or monitor the reel winder.

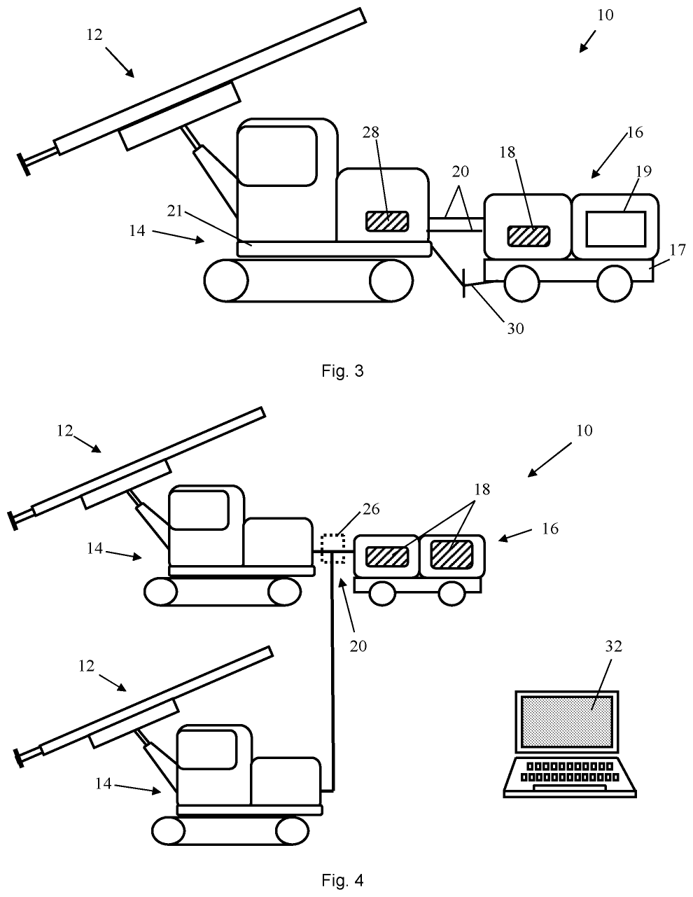

FIG. 3 shows a work device 12 that comprises at least one re-chargeable on-board energy storage device 28, such as a re-chargeable battery, and an external supply unit 16 arranged on an unpowered carriage 17 which comprises a re-chargeable electrical energy storage device 18 and at least one electric and/or hydraulic and/or pneumatic and/or mechanical component.

The at least one electric and/or hydraulic and/or pneumatic and/or mechanical component 19 may be an electric motor, an electric generator, a compressor, a pump, one or more valves, cooling system, a transformer, a electronic filter, an electric or electronic circuit, a sensor, a GPS monitor, a cable or pipe reel winder, a junction box. The components arranged on the external supply unit 16 may be arranged and optionally interconnected in any suitable manner.

One of the components arranged on the external supply unit 16 is connected to at least one work device 12 to supply electric energy to the work device 12 via a connection 20. One of the other components arranged on the external supply unit 16 is connected to at least one work device 12 to supply hydraulic or pneumatic fluid or mechanical force to the work device 12 via another connection 20.

In the illustrated embodiment the unpowered carriage 17 of the external supply unit 16 is connectable to the powered carriage 21 of the work device 12 via a mechanical connection means 30. The mechanical connection means 30 may be used to tow the external supply unit 16 behind the work device 12 when the work device 12 is being moved to a different work site for example. It should be noted that in cases where an external supply unit 16 is provided on a powered carriage 17, the external supply unit 16 may be used to move or tow the at least one work device 12.

Energy may be supplied from the at least one external supply unit 16 to the at least one work device 12 while the work device is being moved to a different location. Supplying energy to the powered carriage 21 of a work unit 12 is namely considered as supplying energy to the work device 12.

The re-chargeable electrical energy storage device 18 arranged on the external supply unit 16 may be used to supply electrical energy to a re-chargeable on-board energy storage device 28 arranged on the work device 12 to recharge it.

The at least one re-chargeable electrical energy storage devices 18, 28 arranged on the at least one external supply unit 16 and the at least one work device 12 respectively may be re-charged at any suitable time, such as before and/or during and/or after the use of the supply unit 16 or work device 12, and/or at night, and/or when the external supply unit 16 or work device 12 is serviced.

According to an embodiment of the invention, a supply unit 16 may comprise at least one converter 22 that is configured to convert electrical energy from an external electricity supply 24, such as an electrical network, to supply to at least one work device 12 and/or to any other part or parts of the mining or construction equipment 10, such as to at least one re-chargeable on-board energy storage device 28 of the mining or construction equipment 10.

According to an embodiment of the invention, electrical energy from one or more sources can be conducted to a plurality of components and/or a plurality of parts of a single component and/or to a plurality of work devices 12 of the mining or construction equipment 10. For example, electrical energy can be conducted from an external electricity supply 24 to a converter 22 located on a supply unit 16 and then to at least one re-chargeable on-board energy storage device 28 of the mining or construction equipment 10 before, or after, or while electrical energy is being conducted from at least one electrical energy storage device 18 located on a supply unit 16 to at least one work device 12. Alternatively, or additionally, hydraulic fluid and/or pneumatic fluid and/or mechanical force can be conveyed from one or more sources to a plurality of components and/or a plurality of parts of a single component and/or to a plurality of work devices 12 of the mining or construction equipment 10.

FIG. 4 shows mining or construction equipment 10 comprising a plurality of work devices 12 connected to a single external supply unit 16 via a branched connection 20. A control unit 26 is located at a node between two branches of the connection 20. The control unit 26 may be configured to communicate with a remote operator 32.

At least one work device 12 and/or at least one external supply unit 16 of the mining or construction equipment 10 according to the present invention may be arranged to be entirely electrically driven with no additional non-electric power supply. Such mining or construction equipment 10 will reduce the cost of ventilation in underground mining or construction operations, and thereby decrease operating costs and improve productivity.

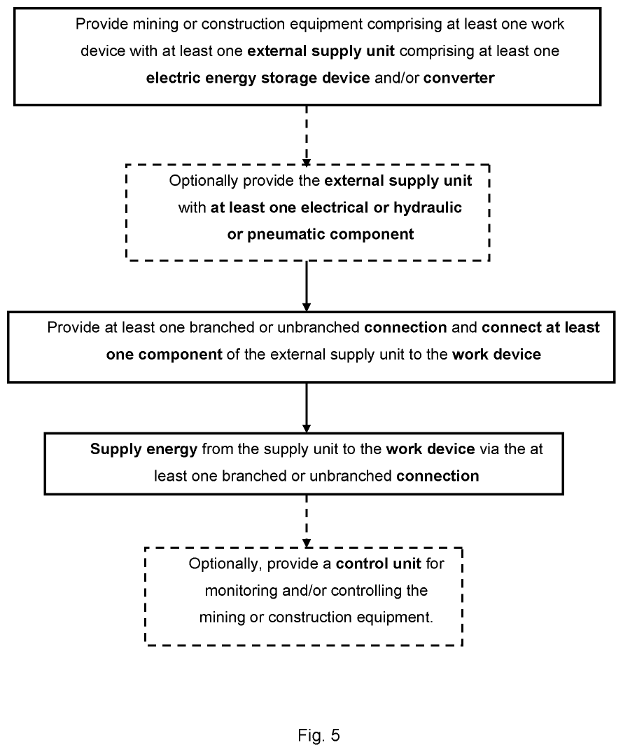

FIG. 5 shows the steps of a method for supplying energy to at least one work device of mining or construction equipment according to an embodiment of the invention. The method comprises the step of providing an external supply unit comprising an electrical energy storage device and/or a converter.

Optionally, the method comprises the step of providing the at least on the external supply unit with at least one electrical or hydraulic or pneumatic or mechanical component.

The method also comprises the steps of providing a branched or unbranched connection, connecting at least one component arranged on the external supply unit to at least one work device via the branched or unbranched connection, and supplying energy to the at least one work device via the at least one branched or unbranched connection.

Optionally, the method comprises the step of providing at least one control unit for monitoring and/or controlling the mining or construction equipment.

It should be noted that the steps of a method according to any embodiment of the invention may be carried in any suitable order.

Further modifications of the invention within the scope of the claims would be apparent to a skilled person. For example, even though the at least one supply unit of the mining or construction equipment according to the present invention is arranged to supply energy to at least one work device, the at least one work device may be used to supply energy to the at least one external supply unit. At least one re-chargeable on-board energy storage device of at least one work device may for example be used to charge at least one electrical energy storage device located on the at least one external supply unit.

1. A mining or construction equipment comprising at least one work device, wherein the mining or construction equipment comprises at least one external supply unit that comprises following components:
at least one electrical energy storage device that is configured to supply energy to the at least one work device,
at least one converter that is configured to convert electrical energy from an external electricity supply to electrical energy for the at least one work device, and to supply the energy to the at least one work device,
the mining or construction equipment also comprises at least one branched or unbranched connection that is configured to connect at least one of the components arranged on the at least one external supply unit to the at least one work device.

2. The mining or construction equipment according to claim 1, wherein the at least one electrical energy storage device comprises at least one of: a battery, a re-chargeable battery, a fuel cell, a capacitor.

3. The mining or construction equipment according to claim 1, wherein the at least one external supply unit also comprises at least one electric and/or hydraulic and/or pneumatic and/or mechanical component, such as at least one of: an electric motor, an electric generator, a compressor, a pump, one or more valves, cooling system, a transformer, an electronic filter, an electric or electronic circuit, a sensor, a GPS monitor, a cable or pipe reel winder, a junction box, mechanical connection means.

4. The mining or construction equipment according to claim 1, wherein the at least one work device and/or the at least one external supply unit is/are each arranged on at least one powered or unpowered carriage.

5. The mining or construction equipment according to claim 1, wherein the at least one external supply unit is mechanically, magnetically, or electromagnetically connectable to the at least one work device.

6. The mining or construction equipment according to claim 1, wherein the at least one work device comprises at least one re-chargeable on-board energy storage device, and the at least one component that is arranged on the at least one external supply unit is configured to supply energy to the at least one re-chargeable on-board energy storage device to recharge it.

7. The mining or construction equipment according to claim 1, comprises at least one control unit configured to monitor and/or control at least one of:
a relative movement between the at least one work device, and the at least one external supply unit,
an extension or location of the at least one branched or unbranched connection,
a supply of energy to the at least one work device and/or the at least one external supply unit,
an amount of electrical energy stored in the at least one electrical energy storage device arranged on the at least one external supply unit,
an amount of energy stored in the at least one re-chargeable on-board energy storage device of the at least one work device, and
at least one work task performed by the at least one work device.

8. The mining or construction equipment according to claim 1, wherein the at least one work device comprises at least one of:
a rock drilling, cutting, loading or hauling device,
a drill rig, such as a face, surface, or well drill rig, an oil and gas drill rig, a rotary blasthole drill rig,
an underground ventilation system device,
an excavator, and
a materials handling device.

9. A method for supplying energy to mining or construction equipment comprising at least one work device, the method comprises the steps:
providing at least one external supply unit comprising following components:
at least one electrical energy storage device, such as at least one of: a battery, a re-chargeable battery, a fuel cell, a capacitor, that is configured to supply energy to the at least one work device,
at least one converter configured to convert electrical energy from an external electricity supply to electrical energy for the at least one work device and to supply the electrical energy to the at least one work device,
providing at least one branched or unbranched connection and connecting at least one of the components to the at least one work device.

10. The method according to claim 9, wherein the method comprises the step of providing the at least one external supply unit with at least one electric and/or hydraulic and/or pneumatic and/or mechanical component, such as at least one of: an electric motor, an electric generator, a compressor, a pump, one or more valves, cooling system, a transformer, an electronic filter, an electric or electronic circuit, a sensor, a GPS monitor, a cable or pipe reel winder, a junction box, mechanical connection means.

11. The method according to claim 9, wherein the method comprises the step of arranging the at least one work device and/or the at least one external supply unit on at least one powered or unpowered carriage.

12. The method according to claim 11, wherein the method comprises the step of mechanically, magnetically, or electromagnetically connecting the at least one external supply unit to the at least one work device.

13. The method according to claim 9, characterized in that it wherein the method comprises the step of providing the at least one work device with at least one re-chargeable on-board energy storage device, and supplying energy from the at least one component arranged on the at least one external supply unit to the at least one re-chargeable on-board energy storage device to recharge it.

14. The method according to claim 13, wherein the method comprises the step of recharging the at least one re-chargeable on-board energy storage device before and/or during and/or after the use of the at least one work device.

15. The method according to claim 9, wherein the method comprises the step of providing at least one control unit and monitoring and/or controlling at least one of:
a relative movement between the at least one work device, and the at least one external supply unit,
an extension or location of the at least one branched or unbranched connection,
a supply of energy to the at least one work device and/or the at least one external supply unit,
an amount of energy stored in the at least one electrical energy storage device that is arranged on the at least one external supply unit,
an amount of energy stored in the at least one re-chargeable on-board energy storage device of the at least one work device,
at least one work task performed by the at least one work device.

16. A computer program product for mining or construction equipment comprising a computer program containing computer program code means arranged to cause a computer or a processor to monitor and/or control at least one of:
a relative movement between the at least one work device, and the at least one external supply unit,
an extension or location of the at least one branched or unbranched connection,
a supply of energy to the at least one work device and/or the at least one external supply unit,
an amount of energy stored in the at least one electrical energy storage device that is arranged on the at least one external supply unit,
an amount of energy stored in the at least one re-chargeable on-board energy storage device of the at least one work device,
at least one work task performed by the at least one work device, wherein the computer program is stored on a computer-readable medium or a carrier wave.
